(19) United States
(12) Patent Application Publication
(10) Pub. No.: US 2025/0330912 A1
(43) Pub. Date: Oct. 23, 2025

(54) METHOD OF IDENTIFYING AMBIENT IOT DEVICES

(71) Applicants: CENTRE OF EXCELLENCE IN WIRELESS TECHNOLOGY, Chennai Tamil Nadu (IN); INDIAN INSTITUTE OF TECHNOLOGY MADRAS (IIT MADRAS), Chennai Tamil Nadu (IN)

(72) Inventors: Deepak Padmanabhan MAYAKUMARI, Chennai Tamil Nadu (IN); Vishakha SINGH, Chennai Tamil Nadu (IN); Thirunageswaram Ramachandran RAMYA, Chennai Tamil Nadu (IN); Jeniston Deviraj Klutto MILLETH, Chennai Tamil Nadu (IN); Bhaskar RAMAMURTHI, Tamil Nadu (IN)

(21) Appl. No.: 19/182,692

(22) Filed: Apr. 18, 2025

(30) Foreign Application Priority Data
Apr. 18, 2024 (IN) 202441031142

(51) Int. Cl. H04W 52/02; G06K 7/10

(52) U.S. Cl. CPC H04W 52/0245; G06K 7/10366

(57) ABSTRACT

The present invention discloses a methods of identifying an A-IoT device in a network. The identification can be performed by the reader at regular intervals to get information about the new devices introduced in the system or devices which were not active for long period of time. The identification can be used by the reader to get identity of the device. Also, it can be used for determining the proximity of the A-IoT device to a reader and a CWN, location of A-IoT device, propagation delay between device and reader, propagation delay between a CWN and a reader through an A-IoT device. These parameters can be used by the reader to determine the parameters for DL and UL transmission for A-IoT device. E.g., the transmit power of DL signal/channel and carrier wave, timing advance to align UL reception from multiple devices, etc.

### FIELD OF INVENTION

The present invention generally relates to Ambient IoT devices. More specifically, the present invention is related to methods of identifying an A-IoT device in a network.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

IoT refers to an ecosystem of a large number of devices in which every device is connected to a wireless sensor network using low-cost self-powered sensor nodes. Ambient IoT devices, also known as ambient intelligence or ambient computing devices, are a subset of IoT devices that operate in the background, using sensors, data analytics, and connectivity to create intelligent and adaptive environments. These devices are often unobtrusive, embedded in our surroundings, and provide a continuous flow of data that can be analyzed and acted upon to improve various aspects of our lives.

In recent years, reduced capability devices with ultra-low power consumption, minimum maintenance cost, and long-life span have attracted much attention in the wireless communication world. A massive number of such devices are expected to be interconnected to improve productivity, efficiency and increase the comforts of life. Further reduction of size, complexity, and power consumption of such devices can enable the deployment of tens or even hundreds of billion devices for various applications and provide added value across the entire value chain. Further, it is impossible to power all such devices by battery that needs to be replaced or recharged manually, which leads to high maintenance cost, serious environmental issues, and even safety hazards in some use cases (e.g., wireless sensor in electric power and petroleum industry). Therefore, energy harvesting can be a potential option to power such devices, where the energy can be harvested using radio waves, light, motion, heat, or any other power source that could be seen suitable.

Radio frequency identification (RFID) is a well-known technology exhibiting above mentioned features. RFID supporting battery less tags has been used in many kinds of applications, such as retail and logistics and has been trialed for manufacturing logistics. However, manual scanning is needed, since the effective communication range is a few meters, which leads to labor intensive and time-consuming operations, or RFID portals/gates, leading to costly deployments. Moreover, the lack of interference management scheme results in severe interference between RFID readers and capacity problems, especially in case of dense deployment. Therefore, there is a need to provide methods and systems to support large-scale networks with seamless coverage for RFID.

### SUMMARY OF THE INVENTION

In general, embodiments of the present disclosure herein provide methods of identifying an A-IoT device in a network. Other implementations will be or will become, apparent to one with skill in the art upon examination of the following figures and detailed description. It is intended that all such additional implementations be included within this description be within the scope of the disclosure and be protected within the scope of the following claims.

In one embodiment, the present disclosure provides a method of identifying nodes in a wireless communication system. The method comprises, transmitting, by at least one first node, a first message, wherein the first message comprises at least one identifier, at least one resource for transmission of a second message by at least one second node and at least one time duration for at least one of ON and OFF. The method further comprises, receiving, by the at least one first node, at least one second message, wherein the at least one second message comprises at least one of: at least one random identity generated by the at least one second node, and at least one identity of the at least one second node. The method further comprises, transmitting, by the at least one first node, a response message, wherein the response message comprises at least one of: at least one random identity, and at least one identity of the at least one second node.

In another embodiment, the present disclosure provides a method of identifying nodes in a wireless communication system. The method comprises, receiving, by at least one second node, a first message, wherein the first message comprises at least one identifier, at least one resource for transmission of a second message and at least one time duration for at least one of ON and OFF. The method further comprises, performing one of backscattering and transmitting, by the at least one second node, at least one second message, wherein the at least one second message comprises at least one of: at least one random identity generated by the at least one second node, and at least one identity of the at least one second node. The method further comprises, receiving, by the at least one second node, a response message, wherein the response message comprises indication about one of: successful completion of identification procedure, and failure of identification procedure.

The above summary is provided merely for the purpose of summarizing some exemplary embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates an exemplary architecture which shows the connection between a reader and an A-IoT device according to an embodiment of the present disclosure;

FIG. 2 illustrates block diagram of the reader and the A-IoT device according to an embodiment of the present disclosure;

FIG. 3a-3b illustrates scenarios of operation of A-IoT device and reader according to an embodiment of the present disclosure;

FIG. 4 illustrates an architecture of an A-IoT device according to an embodiment of the present disclosure;

FIG. 5 illustrates another architecture of an A-IoT device (402) according to an embodiment of the present disclosure.

FIG. 6 illustrates a method A-IoT deployment and device specific timing advance calculation resolution procedure in identification of A-IoT device in a network in accordance with an embodiment of the present disclosure;

FIG. 7a-7b illustrates a method of contention resolution procedure in identification of A-IoT device in a network in accordance with an embodiment of the present disclosure;

FIG. 8a-8b illustrates another method of contention resolution procedure in identification of A-IoT device in a network in accordance with an embodiment of the present disclosure;

FIG. 9a-9b illustrates a method of multiplexing of A-IoT devices in a network in accordance with an embodiment of the present disclosure;

FIG. 10 illustrates a method of identifying nodes in a wireless communication system in accordance with an embodiment of the present disclosure;

FIG. 11 illustrates another method of identifying nodes in a wireless communication system in accordance with an embodiment of the present disclosure.

A more complete understanding of the present invention and its embodiments thereof may be acquired by referring to the following description and the accompanying drawings.

### DETAILED DESCRIPTION OF THE INVENTION

The detailed description set forth below in connection with the appended drawings is intended as a description of various embodiments of the present invention and is not intended to represent the only embodiments in which the present invention may be practiced. Each embodiment described in this invention is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details.

Some embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

Embodiments herein are described within the context of 5G NR radio technology. It is to be appreciated that the problems and solutions mentioned herein apply equally to wireless access networks and UEs that use different access technologies and standards. NR is used as an example technology where embodiments are appropriate, and include NR in the description is therefore very valuable for understanding the problem and finding solutions to it. In particular, embodiments are equally applicable to 3GPP LTE, or 3GPP LTE plus NR integration.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, tracking device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a New Radio (NR) Node B (also referred to as a gNB or gNodeB), etc.

The detailed description includes specific details for the purpose of providing a thorough understanding of the present invention. However, it will be apparent to those skilled in the art that the present invention may be practiced without these specific details.

The present disclosure addresses the aforementioned challenges by providing a methods of identifying an A-IoT device in a network. The identification can be performed by the reader at regular intervals to get information about the new devices introduced in the system or devices which were not active for long period of time. The identification can be used by the reader to get identity of the device. Also, it can be used for determining the proximity of the A-IoT device to a reader and a CWN, location of A-IoT device, propagation delay between device and reader, propagation delay between a CWN and a reader through an A-IoT device. These parameters can be used by the reader to determine the parameters for DL and UL transmission for A-IoT device. E.g., the transmit power of DL signal/channel and carrier wave, timing advance to align UL reception from multiple devices, etc.

The present disclosure also describes capabilities and functionalities supported by the A-IoT devices and how these capabilities and functionalities are informed to the reader so that the reader can utilize them for efficient communication.

Ambient IoT (A-IoT) devices are an alternate class of reduced capability devices in cellular technology. The communication range of A-IoT devices is larger compared to RFID. An A-IoT reader is expected to support a communication range of tens of meters for indoor scenarios. Further, the cellular gNB can be reused as A-IoT readers to minimize the deployment cost and cellular bands/technologies can be reused to improve performance. Furthermore, a network which scales with the number of devices or A-IoT readers should also be supported for practical deployments, and it should be able to adapt to e.g., interference between A-IoT readers to avoid the cost of complicated network planning. The use cases for A-IoT devices can be broadly classified into four categories such as tag identification, sensor monitoring, target tracking and actuator. Typical scenarios such as automated warehousing, automobile manufacturing, and medical instruments inventory management etc. Sensor monitor refers to the detection of KPI data in the surrounding environment through sensors, and then, using these data to make corresponding judgments to achieve corresponding detection purposes, including danger, disaster, and health detection and data reporting. Target tracking is an application that uses the network to obtain A-IoT device location information to locate targets, including item finding, positioning and tracking, etc. An actuator is a device that converts energy into motion. It does this by taking an electrical signal and combining it with an energy source. An actuator comes in a few different guises, including Pneumatic, Hydraulic, Electric, Thermal and Magnetic.

The A-IoT devices can be classified into following categories based on the capability to receive control information and to backscatter or transmit signal:
Cat1: Device without control unit and hence cannot receive any control information from the reader. The device can operate in a certain frequency range depending on circuitry and backscatter (BSc) any signal indenting in the operating frequency range.
Cat2: Device with Control unit (CU) to receive control information (CI) from the reader/network. The CI can be used to control the operation of the device. E.g., the frequency of operation, the scheduling for DL/UL, etc. The device operates in certain band depending on circuitry or control, receives CI in DL and BSc signals in UL based on CI. The BSc signal can be a modulated and amplified version of the incoming signal.
Cat3: Device with CU to receive CI. Further, the device can generate signal and transmit signal to reader/network based on CI.

An A-IoT device deployment can include following entities, an A-IoT Reader, an IoT device and the carrier wave node (CWN). An A-IoT reader controls the operation of an A-IoT device. The A-IoT reader can be handheld, mounted to infrastructure (e.g. base station (A-IoT reader), a user equipment (UE) etc. It may or may not be battery constrained (depending on the scenario) and can (but not necessarily need to) connect to an A-IoT server. The A-IoT reader is responsible for managing communication with the A-IoT devices. The A-IoT reader establish connection with A-IoT device, sends commands/control, collects data from the A-IoT devices, and coordinate their activities. The A-IoT reader may be connected to a large network or the internet, enabling data exchange with other systems or cloud services.

An A-IoT device can be attached to any object, and can connect to an A-IoT reader with an A-IoT radio. The tag may not have any active connection to an A-IoT server. Any signal/information exchange between the A-IoT device and the server is via the A-IoT reader (e.g. A-IoT device signature, configuration, data reporting) and is controlled by the A-IoT reader.

Cat1 and Cat2 A-IoT devices mainly work on the principle of backscatter communication. The backscatter transmitter (e.g., A-IoT device) reflects the carrier wave and modifies one or more characteristics (e.g., amplitude, phase, or center frequency) of the reflected signal according to the information bits stored in its memory. Communication via back scattering instead of active radiation reduces the RF frontend of the A-IoT device (E.g. tag and sensor etc.) to a single transistor switch, which minimizes the manufacturing cost as well as energy demands. The node which transmits carrier waves is known as carrier wave node (CWN).

The carrier wave can be transmitted by the A-IoT reader itself or using an external node, a.k.a. carrier wave node (CWN), near to the A-IoT device. In case of A-IoT reader transmitting the carrier, the pathloss encountered by the backscattered wave is twice the distance between A-IoT reader and the A-IoT device which significantly reduces the coverage. Further, transmission of carrier wave and reception of backscattered signal happen simultaneously at the A-IoT reader, demanding full duplex operation. Also, the transmitted carrier wave interferes with the reception of backscattered signal, a.k.a. self-interference, and impacts the performance of the system. The advantage with latter method (using CWN) is reduction in pathloss and increase in coverage as the node generating carrier wave is near to the A-IoT device. Further, it reduces interference at the A-IoT reader as the A-IoT reader is only receiving from the A-IoT device.

The A-IoT device derives energy to turn on the modulating and backscattering circuitry using the energy harvesting mechanism. The energy harvesting can be performed using carrier wave provided externally using an CWN, RF signal, solar energy etc. Once the A-IoT device has harvested sufficient energy it turns on the circuitry, modulates the carrier wave based on the stored value and back scatter modulated carrier wave to the A-IoT reader. The energy remaining after backscattering can be stored in the A-IoT device depending on the energy storing capability of the A-IoT device. The energy harvesting process can be continuous or discontinuous. In continuous case the device harvest energy continuously irrespective of whether communication with reader is initiated or ongoing, whereas in discontinuous case the energy harvesting starts only when communication with reader is initiated or energy storage goes below certain threshold.

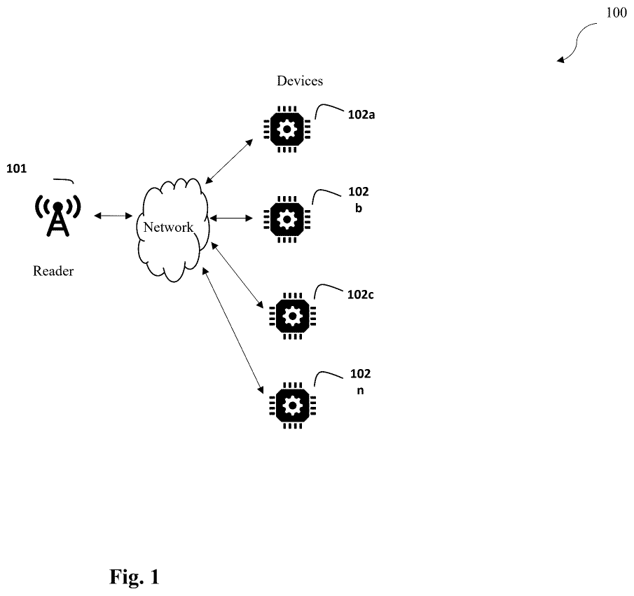

An exemplary system is illustrated in FIG. 1 which shows that a reader 101 is wirelessly coupled to one or more devices 102a . . . 102n (collectively referred to as 102). In an embodiment, one or more devices 102 are connected to the reader 101 and information is transmitted, backscattered and received between the reader 101 and the device 102. The reader 101 is responsible for managing communication with the devices 102 and serves as a reader that collects data from the devices 102, sends commands, and coordinates their activities. The reader 101 may be connected to a larger network or the internet, enabling data exchange with other systems or cloud services. In an embodiment, the reader is any one of a handheld device, a base station, a use equipment (UE), Network-Controlled Repeater (NCR), Integrated Access and Backhaul (IAB), repeater, or any combination thereof. In another embodiment, the device is at least one of an ambient IoT device and IoT device. In a further embodiment, the ambient IoT devices is any one of Cat1 A-IoT device, Cat2 A-IoT device, or Cat3 A-IoT device or any combination thereof.

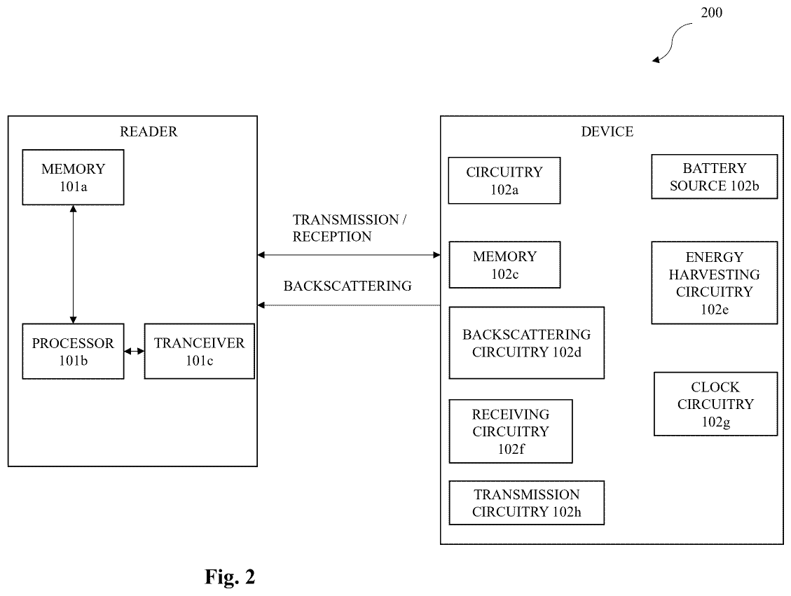

FIG. 2 illustrates a general block diagram of the reader 101 and the device 102 according to an embodiment of the present disclosure. The reader 101 comprises a memory 101a, a processor 101b and a transceiver 101c. In an example, the processor 101b includes a processor(s) that may be a single processing unit or a number of units, all of which could include multiple computing units. The processor 101b may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor 101b is configured to fetch and execute computer-readable instructions and data stored in the memory 101a. The memory 101a may include any non-transitory computer-readable medium known in the art including, for example, volatile memory, such as static random-access memory (SRAM) and dynamic random access memory (DRAM), and/or non-volatile memory, such as read-only memory (ROM), erasable programmable ROM, flash memories, hard disks, optical disks, and magnetic tapes. The memory 101a and the processor 101b are coupled to the transceiver 101c for sending and receiving the data/information from the one or more devices 102.

In an embodiment, the device 102 comprises a circuitry 102a and/or a battery source 102b. The circuitry 102a may be provided as a hardware component such as one or more microprocessors, microcomputers, microcontrollers, digital signal processors, central processing units, state machines, logic circuitries, and/or any devices that manipulate signals based on operational instructions. In an embodiment, the devices are equipped with a battery source 102b. Further, the device may comprise a memory 102c which for example, may comprise device ID or pre-configured information. In a further embodiment, the device 102 comprises a backscattering circuitry 102d, an energy harvesting circuitry 102e, a receiving circuitry 102f, a clock circuitry 102g and a transmission circuitry 102h.

The presence of battery source 102b helps in signal amplification or even independent Radio Frequency signal generation. The batteries 102b also allow for greater flexibility, including mobility in their deployment, as they are not dependent on external energy sources. However, efficient power management is crucial to extend the operational lifespan of these devices, as replacing batteries in large-scale deployments can be costly and sometimes become impractical. This topology is commonly employed in applications such as environmental monitoring, asset tracking, and industrial automation, command, and positioning, where the reader and devices work together to collect and transmit data for analysis and decision-making.

Battery based devices are mainly used in the outdoor scenarios or where the distance between reader and the devices is large. The device needs to connect with reader, and it has to synchronize in downlink as well as in uplink. The Downlink and Uplink synchronization, called as initial access procedure refers to the process a device follows to establish a connection with a reader. This procedure is crucial for allowing the device to access the network and start using its services.

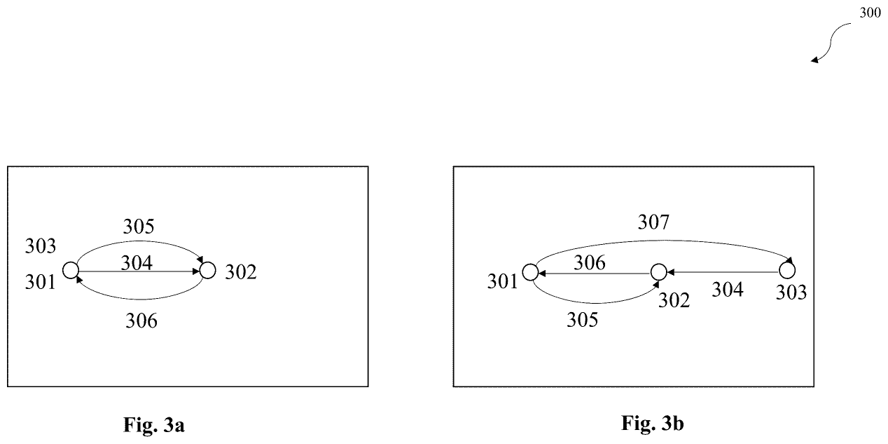

FIG. 3a-3b illustrates scenarios of operation of A-IoT device and reader according to an embodiment of the present disclosure. The A-IoT devices 302 can be employed in both monostatic and bi-/multi-static configurations, where the term monostatic is used when both the CWN 303 and the A-IoT reader 301 functionalities are performed by the same device as illustrated in the FIG. 3a of the present disclosure, while bistatic deployment specifies the scenario where the CWN 303 and the A-IoT reader 302 are physically two different devices as illustrated in the FIG. 3b of the present disclosure. There are four links associated with the A-IoT reader 301, A-IoT device 302 and the CWN 303 in this case, the first one is the link 304 between the CWN and the A-IoT device 302, second one is the link 306 between the A-IoT device 302 and the A-IoT reader 301, third one is link 305 between the A-IoT reader 301 and the A-IoT device 302 and finally the link 307 between the A-IoT reader 301 and the CWN 303.

The carrier wave can be transmitted by the A-IoT reader 301 itself or using an external node, a.k.a. CWN 303, near to the A-IoT device 302. In case of A-IoT reader 301 transmitting the carrier, the pathloss encountered by the backscattered wave is twice the distance between A-IoT reader 301 and the A-IoT device 302 which significantly reduces the coverage. Further, transmission of carrier wave and reception of backscattered signal happen simultaneously at the A-IoT reader 301, demanding full duplex operation. Also, the transmitted carrier wave interferes with the reception of backscattered signal, a.k.a. self-interference, and impacts the performance of the system. The advantage with latter method (using CWN 303) is reduction in pathloss and increase in coverage as the node generating carrier wave is near to the A-IoT device 302.

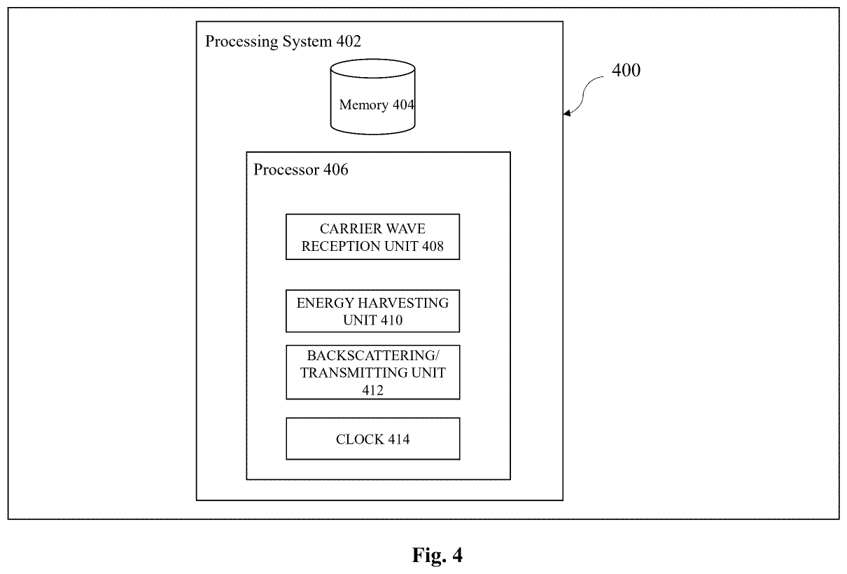

FIG. 4 illustrates an architecture of an A-IoT device 400 according to an embodiment of the present disclosure. In some implementations, the A-IoT device 400 may include one or more processing system 402. The processing system(s) 402 may be configured by memory 404 in communication with the processor 406. The processor 406 may include a carrier wave reception unit 408, an energy harvesting unit 410, a backscattering/transmitting unit 412 and a clock 414 to control the process. The carrier wave reception unit 408 receives carrier wave from CWN and forward it to energy harvesting unit 410 to harvest energy during energy harvesting phase. In the backscattering phase, the carrier wave is routed to the backscattering/transmitting unit 412 to modulate the incoming carrier wave according to the information and backscatter to the A-IoT reader. The operations are performed based on clock 414 present at the A-IoT device 400. The clock 414 at the A-IoT device 400 should be synchronized with the clock or timing at the A-IoT reader to establish an effective communication. There are two links associated with A-IoT devices in this case, the first one is the link between CWN and carrier wave reception unit and the second one is the link between carrier wave reception unit and A-IoT reader.

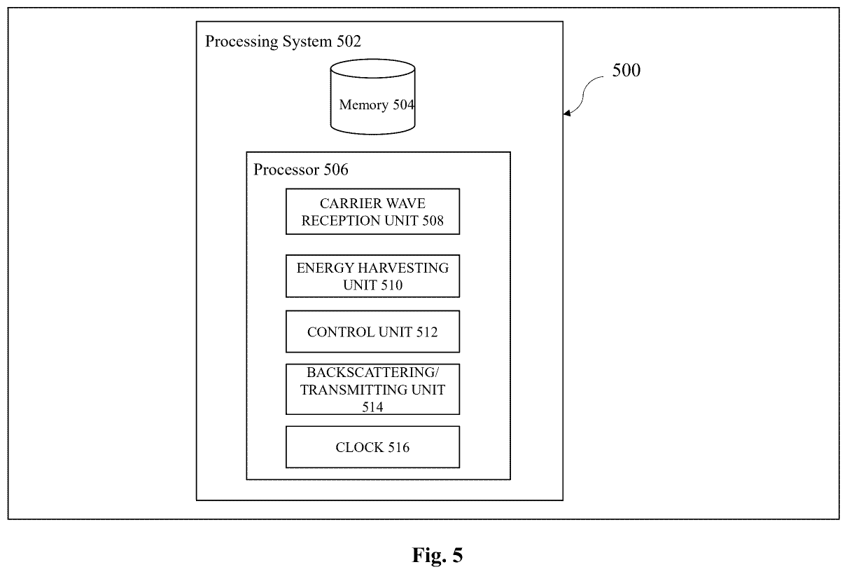

FIG. 5 illustrates another architecture of an A-IoT device 500 according to an embodiment of the present disclosure. In some implementations, the A-IoT device 500 may include one or more processing system 502. The processing system(s) 502 may be configured by memory 504 in communication with the processor 506. The processor 506 may include a carrier wave reception unit 508, an energy harvesting unit 510, a control unit 512, a backscattering/transmitting unit 514 and a clock 516. The carrier wave reception unit 508 receives carrier wave from CWN and forward it to energy harvesting unit 510 or backscattering/transmitting unit 514. The energy harvesting unit 512 harvest energy using the carrier wave. The control unit 510 performs establishing connection with A-IoT reader, monitoring for control signal, performing synchronization, etc. The backscattering/transmitting unit 514 modulates the incoming carrier wave according to the information and backscatter to the A-IoT reader. All the operations are performed based on clock 516 present at the A-IoT device 500. The clock 516 at the A-IoT device 500 should be synchronized with the clock or timing at the A-IoT reader to perform efficient communication. There are three links associated with A-IoT device 500 in this case, the first one is the link between CWN and carrier wave reception unit, second one is the link between carrier wave reception unit and A-IoT reader and finally the control link between A-IoT reader and the control unit at A-IoT device.

It should be noted that, it should be understood that division of the modules of the foregoing apparatus is merely division of logical functions, and in actual implementation, all or some modules may be integrated into one physical entity, or may be physically separated. In addition, all of these modules may be implemented in a form of invoking software by a processor element, or all of these modules may be implemented in a form of hardware, or some modules are implemented in a form of invoking software by a processor element, and some modules are implemented in a form of hardware. For example, the receiving module may be a separately disposed processor element, or may be integrated into a chip of the foregoing apparatus for implementation. In addition, the receiving module may alternatively be stored in a memory of the foregoing apparatus in a form of program code, and a processor element of the foregoing apparatus invokes and executes a function of the foregoing receiving module. Implementation of other modules is similar to that of the receiving module. In addition, all or some of these modules may be integrated together, or may be implemented separately. The processor element described herein may be an integrated circuit and has a signal processing capability. In an implementation process, steps in the foregoing methods or the foregoing modules can be implemented by using a hardware integrated logical circuit in the processor element, or by using instructions in a form of software.

For example, the foregoing modules may be one or more integrated circuits configured to implement the foregoing method, for example, one or more application-specific integrated circuits (ASIC), or one or more microprocessors (DSP), or one or more field programmable gate arrays (FPGA), or the like. In another example, when one of the foregoing modules is implemented in a form of invoking program code by a processor element, the processor element may be a general-purpose processor, for example, a central processing unit (CPU) or another processor that can invoke the program code. For another example, the modules may be integrated together and implemented in a form of a system-on-a-chip (SOC).

All or some of the foregoing embodiments may be implemented by using software, hardware, firmware, or any combination thereof. When software is used to implement the embodiments, all or some of the embodiments may be implemented in a form of a computer program product. The computer program product includes one or more computer instructions. When the computer program instructions are loaded and executed on a computer, the procedures or functions according to embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive (SSD)), or the like.

### Method of Identification

### Identification Procedure 1

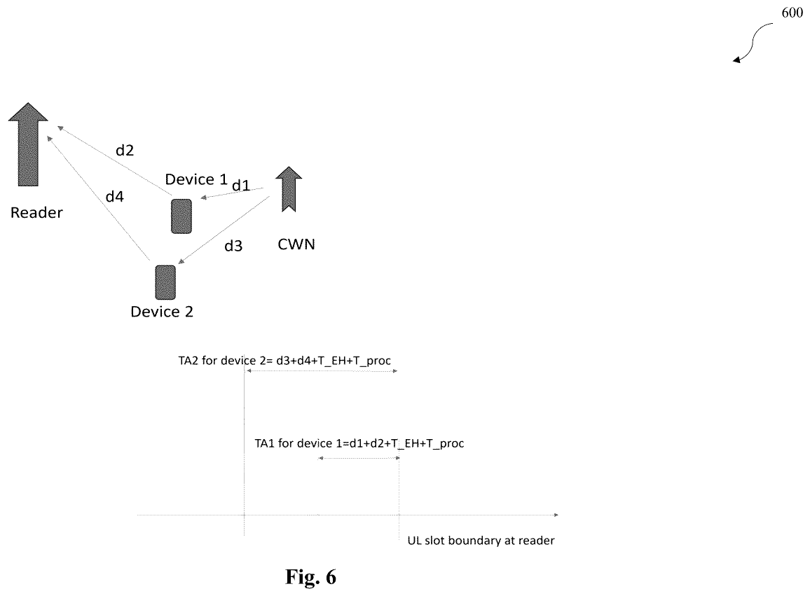

FIG. 6 illustrates a method A-IoT deployment and device specific timing advance calculation resolution procedure in identification of A-IoT device in a network in accordance with an embodiment of the present disclosure. This method is applicable for a Cat1 device which is not capable of receiving any control information from the reader. The method comprises a CWN transmitting preamble, the device modulating the preamble with its identity (ID) and backscatter it. The configuration for transmitting the preamble can be configured to the CWN by the reader. The configuration comprises preamble to transmit (e.g., preamble ID, root sequence, shifting factor, etc.), time and frequency resource to transmit preamble, transmit power, beamforming configuration (beam ID or precoder) etc. In another option the time and frequency resource to transmit the preamble can be derived by the CWN from the preamble configured by the reader. In that case the mapping between preamble and associated time-frequency resource is predefined in the standards.

The backscattered signal (BSc) signal is received by the reader. The preamble can be BSc by multiple devices and hence the reader may receive multiple copies of the same preamble (i.e., contention). The reader determines ID of the device (i.e., the device which is identified) from the received signal, determine propagation delay from the received preamble and compute timing advance corresponding to the identified device. The propagation delay is for the link between CWN to reader through the identified device and it includes processing time at the device, energy harvesting time at the device, etc.
In an embodiment, for normal UL operation from device, the reader indicates to the CWN the ID of the device scheduled in UL along with scheduling information and the CWN apply TA while transmitting carrier wave to the device. E.g., the reader indicates (device 1, TA1), (device 2, TA2), etc. to the CWN in random access response (RAR). During normal UL scheduling from device 1, the reader indicates (device 1, slot n, centre frequency, bandwidth) to the CWN. In response, the CWN generate carrier wave according to the centre frequency and bandwidth signalled and advances the transmission of carrier wave by factor TA1 from slot n, as illustrated in FIG. 6, so that the BSc signal from device1 will reach reader exactly at the UL boundary. Similar is the case with UL from device 2.
In another embodiment, for normal UL operation from a device, the reader indicates to the CWN the TA to be applied along with time frequency resource. E.g., during normal UL scheduling from device 1, the reader indicates (TA1, slot n, centre frequency, bandwidth) to the CWN. In response, the CWN generate carrier wave according to the centre frequency and bandwidth signalled and advances the transmission of carrier wave by factor TA1 from slot n, as illustrated in FIG. 6. Here the device scheduled in a time instant is unknown to the CWN.

In the identification procedure as illustrated in FIG. 6, the A-IoT device is unaware of the identification process whether it got identified etc. Device simply backscatter whenever enough energy and carrier wave is present. However, the UL reception at the reader will be aligned with slot boundary only for the devices, which passed the identification procedure. Hence, the reader will decode UL information from BSc signal only for the devices which passed the identification procedure.

### Identification Procedure 2

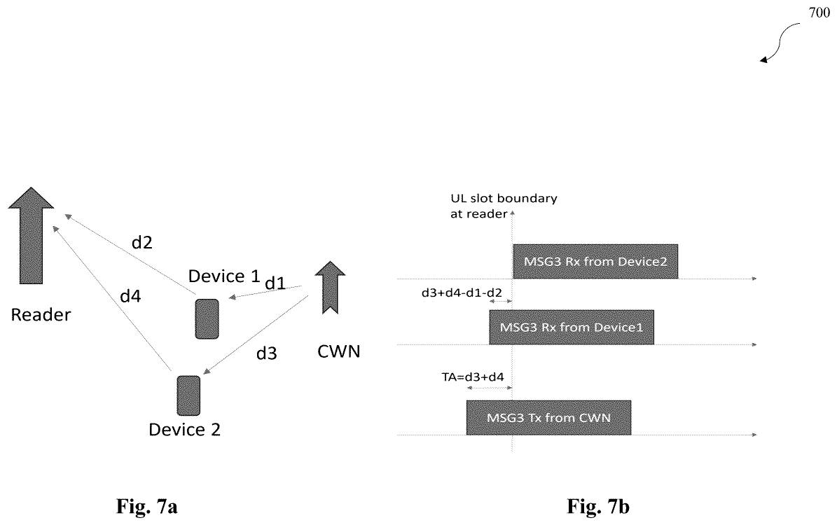

FIG. 7a-7b illustrates a method of contention resolution procedure in identification of A-IoT device in a network in accordance with an embodiment of the present disclosure. This method is applicable for a Cat2 device which can receive control information.

In an embodiment, the method comprises a CWN transmitting preamble, the device modulating the preamble with its identity (ID) and BSc it. The configuration for transmitting the preamble and its signalling is same as illustrated in FIG. 6. The reader receives BSc signal, resolve contention, determine ID of the identified device, and compute the propagation delay from received preamble, as illustrated in FIG. 6. The reader transmits response to the CWN and the device indicating completion of identification process, ID of the identified device, TA corresponding to the identified device, etc. The device will check the ID received in the response with the ID modulated in preamble and if a match is found then declare the identification success. If the ID is not matching, then the device repeats the process in next occasion configured for identification. The TA is computed with respect to the CWN, hence for normal UL operation the CWN transmits carrier wave according to the control information signalled by the reader. The details are same as illustrated in FIG. 6.

In another embodiment, the device can be indicated with the occasion for identification, so that the device BSc the preamble transmitted by the CWN without modulation. The indication can be a broadcast information (e.g., query). The advantage with this method is that the tampering of preamble due to modulation can be avoided. The reader receives multiple copies of BSc preamble from different devices, select a preamble received and compute propagation delay based on the selected preamble. The selected preamble will correspond to a device and the calculated propagation delay will be from the CWN to the reader through the device. Further, the reader transmits response message to the CWN and the device. The response message comprises scheduling information for next UL transmission (e.g. MSG3), device ID, information to generate device ID, TA, etc.

The CWN receives response message and transmit carrier wave according to the TA and scheduling information in response message. The device receives the response message from the reader, generate its ID based on the information in the response message, modulate the carrier wave transmitted by CWN using the ID and BSc the modulated signal to the reader. Multiple devices can receive response message and can BSc the carrier wave transmitted by the CWN; hence contention can happen. However, TA applied for the UL signal corresponds to only one device and hence the BSc signal from only one device will align with UL slot boundary at the reader. The reader receives UL message (BSc signal) according to the UL slot boundary, resolve contention and determine ID of the device, which passed the procedure, from the UL signal. Further, the reader transmits the contention resolution message to the device and CWN. The contention resolution message contains ID of the device, which passed the procedure, identification complete message, etc. The device check ID, received in the contention resolution message, with the ID modulated in the BSc signal and if a match is found then declare the identification success. If the ID is not matching, then the device repeats the process in the next occasion configured for identification. For normal UL transmission from the device, the CWN apply the TA for transmitting carrier wave depending on the control information received from the reader.

An e.g., for contention resolution for identification procedure 2 is illustrated in FIG. 7b. Here, both Device1 and Device2 BSc the preamble transmitted by the CWN in step 1. Therefore, the reader receives 2 copies of the same preamble. However, the phase rotation of the received preambles will be different as the propagation delay between reader and the devices are different. The reader selects the BSc preamble by Device2, compute TA based on d3+d4 (i.e., the propagation delay between reader and Device 2) and indicate it to the CWN in the response message. Now, the CWN transmits MSG3 according to the TA=d3+d4 and both devices BSc the MSG3 after modulation. Since TA was calculated based on d3+d4, the BSc MSG3 from Device2 aligns with UL slot boundary at the reader, whereas the BSc MSG3 from Device1 reaches the reader earlier, as indicated in FIG. 7b. The reader only treats MSG3 aligning with slot boundary as valid, determine ID of Device 2 and send it in contention resolution message.

### Identification Procedure 3

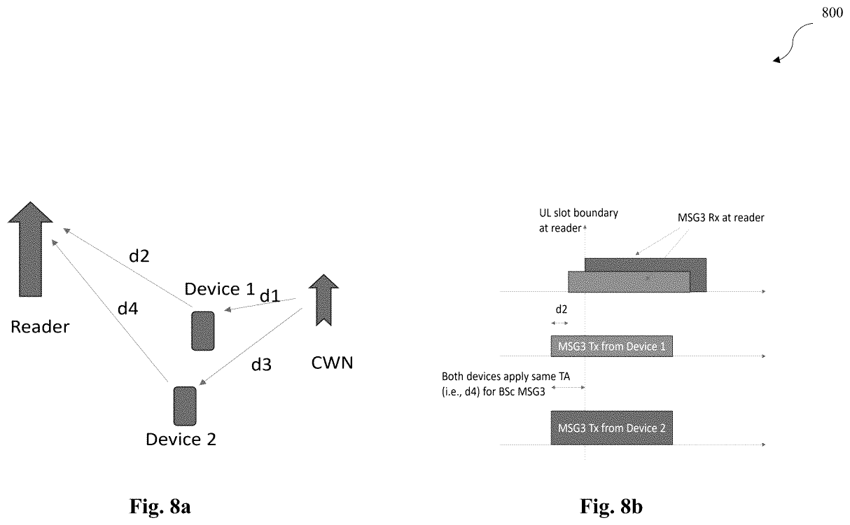

FIG. 8a-8b illustrates another method of contention resolution procedure in identification of A-IoT device in a network in accordance with an embodiment of the present disclosure. This method is applicable for a Cat2 device which can receive control information. In an embodiment, the device can be configured/indicated with the occasion for identification and preamble transmission. The indication can be a broadcast information (e.g., in query). Further the device can be configured with the preamble (e.g., preamble ID) or information to generate a preamble (e.g., root sequence, shifting factor, etc.).

In another embodiment, set of preambles can be predefined in standards from which the device can select a preamble randomly. The device modulates the carrier wave with the preamble and BSc to the reader. The contention can happen because multiple devices can modulate the carrier wave with same preamble. The reader receives BSc signal, identify the preambles received and compute the propagation delay based on the preambles. In case of receiving multiple copies of the same preamble, the reader selects one copy, that corresponds to a device, and determine propagation delay based on the selected preamble. Further, the reader determines TA corresponding to the determined propagation delays. Here, the propagation delay and TA are corresponding to the link between device and reader.

The reader transmits response message to the CWN and the device. The response message comprises scheduling information for next UL transmission (e.g. MSG3), device ID, information to generate device ID, TA, etc. The device receives a response message, determine device ID based on information in response message, modulate the carrier wave using the device ID and BSc the modulated carrier wave according to the scheduling information and TA indicated in the response message. Similar to the method illustrated in FIG. 7a-7b, here also multiple devices, irrespective of whether the preamble transmitted in step 1 is selected by the reader or not, receives the response message, generate the ID and BSc the ID in the UL message. However, the TA indicated in the response message is corresponding to the preamble selected by the reader, which in turn corresponds to a device in the system. Hence, the BSc signal from only that device will align with the UL slot boundary at the reader and the reader will only consider UL signals aligning with UL slot boundary. Therefore, the contention can be resolved. Further, the reader determines the ID of the device from the received UL signal and transmits the contention resolution message to the device and the CWN. The contention resolution message contains the ID of the device, which passed the procedure, identification complete message, etc. The device receives the contention resolution message, compare the ID received in the contention resolution message with the ID BSc in the UL signal and if a match is found then declare the identification as success. If the ID received in the contention resolution message is not matching with the ID BSc in the UL signal, then the device repeats the process in the next occasion configured for the identification.

An e.g., for contention resolution for identification procedure 3 is illustrated in FIG. 8b. Here, both Device1 and Device2 have modulated the carrier wave with the same preamble in step 1. Therefore, the reader receives 2 copies of the same preamble. However, the phase rotation of the received preambles will be different as the propagation delay between reader and devices are different. The reader selected the preamble transmitted by Device2, compute TA based on d4 (i.e., the propagation delay between reader and device 2) and indicate it to the devices in the response message. Both Device1 and Device2 receive the response message, modulate the carrier wave with the ID and BSc the MSG3 according to the TA signalled. Since the TA was calculated based on the distance between the reader and the D2 (i.e., d4), the BSc MSG3 from Device2 aligns with UL slot at reader, whereas the BSc MSG3 from the Device1 reaches the reader earlier, as indicated in FIG. 8b. The reader only treats the MSG3 from the Device2 as valid and send the ID of the Device2 in the contention resolution message.

In another embodiment, the CWN can transmit carrier waves whenever information is required from A-IoT device, so that A-IoT device can harvest energy and transmit information after acquiring sufficient energy. This integrated approach ensures that the A-IoT device can efficiently power itself and communicate data seamlessly with the A-IoT reader through the utilization of energy harvesting and back scattering techniques.

### Method of Tracking the A-IoT Devices

The reader performs the identification of the devices at regular intervals to detect the presence of new devices in the system. Also, the reader maintains a list of devices connected to it and track various parameters (e.g., position of devices, status of devices, sensor output, etc.) of the connected devices. Based on tracking and identification, the reader updates the list of connected devices. E.g., if a new device is identified then the reader add the ID of the device into the list of connected devices. Similarly, if the response from a connected device is not received during tracking, then the ID of the device is removed from the list of connected devices. The reasons for not receiving a response from the device during tracking can be lack of energy at the device, UL failure due to poor channel conditions, non-availability of carrier wave to BSc, the device moved out of coverage, etc. However, the identity of the device can be moved from the list of connected devices only in case the device is moving out of coverage. Therefore, it is essential for the reader to identify the reason for not getting the UL information from the device during tracking. Following methods apply:
The updation (i.e., adding or removing device ID) of the list is done based on multiple tracking attempts. E.g., the reader try to get information from a device for n number of times and if the response is not received for n times continuously then the device ID is deleted from the list of connected devices.
In another method, the device can report during tracking phase status of battery or harvested energy remaining so that the reader can track reason for not receiving any update from the device. The reporting (e.g. warning/battery low) from the device can be when the energy level falls below certain threshold or energy harvesting rate is low or is not occurring. E.g., if the reader received battery low indication from device and is not receiving any further update from the device, then the reader can assume the reason for lack of update is lack of energy at the device. In such cases reader can wait and try to get response from the device after certain delay.
In another option, the reader keep track of set of nearby devices (e.g., devices in same rack) and try to get information about the non-responding device using the nearby devices. E.g., if the nearby devices are responding then the channel condition is good.

The device can be configured with set of parameters for tracking:
Content of BSc signal: The configuration can also include the parameter to BSc, e.g., the ID, sensor value, etc.
Activation/deactivation of the configuration: The BSc can be based on a trigger signal from the reader. The device can be configured with multiple configurations for BSc and the trigger signal can activate one of the configurations for BSc.
Scheduling for BSc: The device can be configured with the time and frequency resource to receive carrier wave and to BSc. The configuration comprises start time, on duration, periodicity, centre frequency, bandwidth, etc.
Modulation parameters: Device can be configured with various parameters with which it has to modulate the BSc signal. E.g., the bit duration for ON-OFF keying.
Power control parameters: The amplification factor to be used by the device for BSc signal. This parameter is essential to control interference created by the device.

### Capability of A-IoT Device and Signalling of Capability

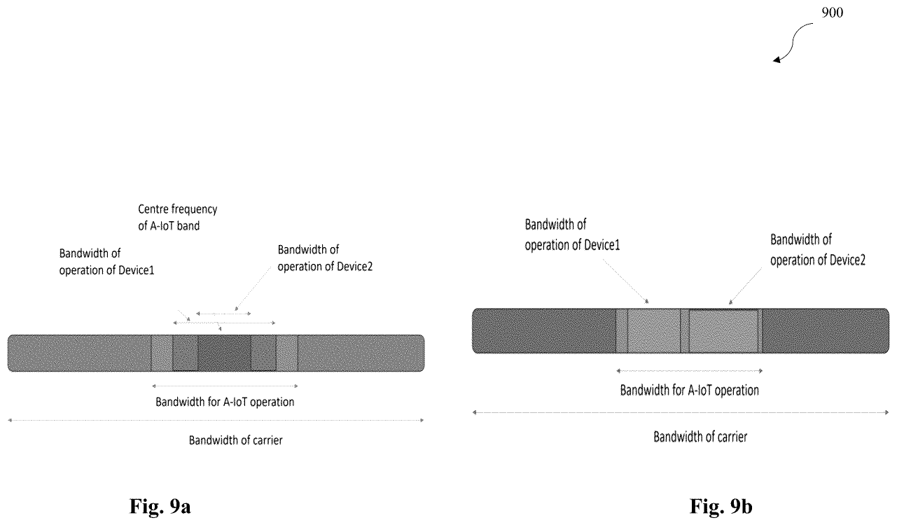

FIG. 9a-9b illustrates a method of multiplexing of A-IoT devices in a network in accordance with an embodiment of the present disclosure. The capability of the device is essential for establishing and maintaining efficient communication. Also, it is needed in determining the method of communication and parameters of communication. Following capabilities can be considered for A-IoT devices:
Bandwidth of operation: The centre frequency and bandwidth supported by the device for receiving the control information from the reader and BSc the UL signals to the reader. The minimum bandwidth supported by every A-IoT device can be predefined and the query/trigger signal for the identification process can be designed for the minimum bandwidth so that every device can access it. The capability further includes whether the device can tune the centre frequency of operation or bandwidth of operation. This is essential in multiplexing devices in time or frequency. E.g., devices with frequency tuning capability can be multiplexed in frequency domain (illustrated in FIG. 9b) whereas the devices without tuning capability have to be TDMed (indicated in FIG. 9a).
Procedures supported: The device can operate based on BSc and transmission. Also, the device can be capable of amplifying the BSc signal. This parameter can be used by the reader to determine whether carrier wave is needed for communicating with the device or not. E.g., if a device is not capable of generating signal and capable of only BSc then carrier wave needed from external node to facilitate the UL communication from the device.
Energy harvesting capability: The time required by the device to attain minimum charge so that it can turn on and communicate with the reader. Capability also includes information about charging/discharging cycle at the device, continuous or discontinuous charging, etc. The charging/discharging cycle can be the charging/discharging pattern after the reception/transmission. E.g., how much charge is consumed in one receiving/transmission process, how much time is needed by the device to perform reception after a reception/transmission, how much time is needed by the device to perform transmission after a reception/transmission, etc. This information is handy in determining the delay in receiving information from the device after triggering. Also, it is necessary in determining the time gap needed to schedule DL/UL from a device. E.g., if the device needs 1 slot duration to harvest energy after a reception, then after triggering the device in slot n, the reader can expect response from device only in slot n+1. In another e.g., a DL control information in slot n can schedule DL/UL in a device only from slot n+1.
Type of device: The device can be categorized into various types depending on capability and the capabilities of each group can be predefined. E.g., the A-IoT devices can be categorized into 3 categories as mentioned in Sec. 1 based on capability to receive control information and transmission/BSc capability.

The capability of the A-IoT device needs to be communicated to the reader so that the reader can efficiently utilize the capabilities of the device. The capability can be informed to the reader either by the device or by the network or at the time of deployment. The device can indicate its capability to the reader during the identification procedure. E.g., the device can signal its capability in the first UL signal or after receiving the identification complete message or after determining by the device the identification is successful.

The capability and type of device can be explicitly signalled to the reader, or it can be implicitly indicated. Following methods can be considered for implicit indication:
In an embodiment, the implicit indication can be using the device type. The devices can be categorized into different types and the capability of each type of device can be predefined. E.g., Cat 1 device has 10 KHz BW support without tunability, performs only BSc, min. harvesting time is 1 ms, etc. In that case, the reader can be informed about the type of device based on which the reader can identify the capability.
In another embodiment the implicit indication can be using the device ID. E.g., the Device ID can have specific format comprising multiple fields of definite size. Each field can correspond to a network id, a device specific id, a device type, rack id, etc. The network id field can be indicated by the reader in the response message in the identification process. The rack ID can be configured to the device during implementation. After receiving the device ID, the reader decodes each field in the ID and determines information about the device (e.g., rack in which device is present, type of device, etc.).

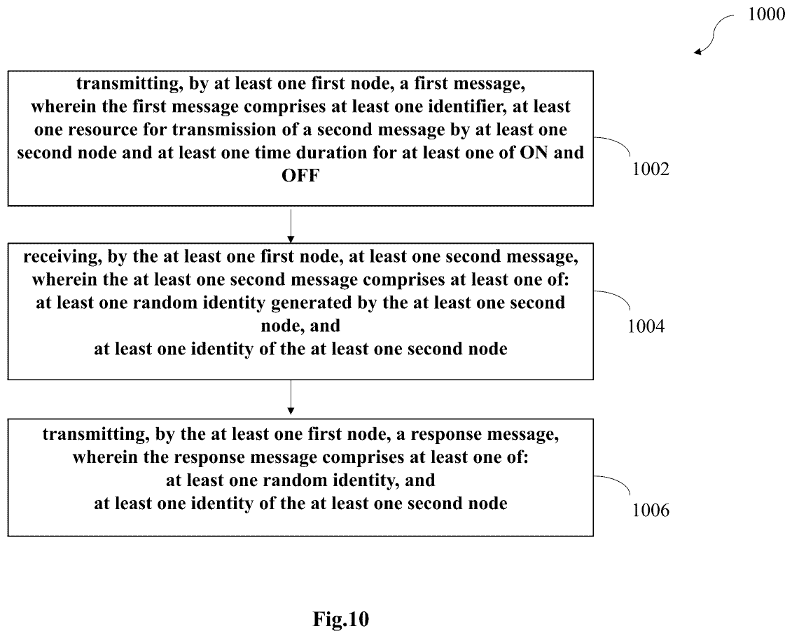

FIG. 10 illustrates a method of identifying nodes in a wireless communication system in accordance with an embodiment of the present disclosure. The operations of method 1000 presented below are intended to be illustrative. In some implementations, method 1000 may be accomplished with one or more additional operations not described, and/or without one or more of the operations discussed. Additionally, the order in which the operations of method 1000 are illustrated in FIG. 10 and described below is not intended to be limiting.

According to an embodiment, the method 1000 may be implemented by one or more processors or modules illustrated and explained through FIGS. 1-5, therefore detailed explanation of the same is omitted here for the sake of brevity.

Step 1002 may include transmitting, by at least one first node, a first message, wherein the first message comprises at least one identifier, at least one resource for transmission of a second message by at least one second node and at least one time duration for at least one of ON and OFF.

Step 1004 may include receiving, by the at least one first node, at least one second message, wherein the at least one second message comprises at least one of: at least one random identity generated by the at least one second node, and at least one identity of the at least one second node.

Step 1006 may include transmitting, by the at least one first node, a response message, wherein the response message comprises at least one of: at least one random identity, and at least one identity of the at least one second node.

In an embodiment, the response message is one of the same and a subset of the at least one second message.

In an embodiment, the at least one identifier comprises at least one of: an identity of a service request; an identity of the at least one first node; and at least one identity of the at least one second node.

In an embodiment, the at least one resource for the second message comprises at least one of: at least one time resource; at least one time offset; at least one periodicity; at least one frequency resource; at least one frequency shift; a carrier frequency; at least one spatial resource; and at least one power control information.

In an embodiment, the at least one spatial resource comprises at least one identity of one of a beam and a precoder.

In an embodiment, the time is represented using at least one of a slot index, a number of slots, a symbol index and a number of symbols.

In an embodiment, the frequency resource is represented using at least one of a resource block index, a sub carrier spacing, a number of resources blocks, a subcarrier index, identity of at least one bandwidth part and a number of subcarriers.

In an embodiment, the at least one second message comprises at least one of a preamble, a reference signal, a sequence and a carrier wave.

In an embodiment, the at least one of the preamble, the reference signal, and the sequence is one of a predefined and indicated in the first message.

In an embodiment, the first message further comprises at least one of: an indication for the at least one second node to start receiving, an information about the clock, at least one information to generate at least one of: the at least one random identity, and the at least one identity of the at least one second node; an indication for one of transmit and backscatter the second message; an information about content of the second message; an indication for one of perform modulation and skip modulation on the second message; at least one orthogonal sequence; at least one preamble ID; at least one root sequence; and at least one shifting factor.

In an embodiment, receiving the at least one second message further comprises at least one of: identifying the at least one second node from where the at least one second message is received; and determining at least one parameter corresponding to the at least one second node identified.

In an embodiment, the at least one parameter is determined using at least one of: at least one of a preamble, a reference signal, a sequence and an information modulated in the at least one second message; and a received power of the at least one second message.

In an embodiment, the at least one parameter comprises at least one of: an identity (ID) of the at least one second node; a type of the at least one second node; a capability of the at least one second node; a channel of the at least one second node; a timing advance (TA) corresponding to the at least one second node; a propagation delay corresponding to the at least one second node; a proximity of the at least one second node; a position of the at least one second node; a processing time at the at least one second node; an energy status of the at least one second node; and an information about energy harvesting at the at least one second node.

In an embodiment, the at least one parameter is determined for one of: a link between the at least one first node and a third node through the at least one second node; and a link between the at least one first node and the at least one second node.

In an embodiment, the type of the at least one second node is determined based on the ID of the at least one second node.

In an embodiment, the capability of the at least one second node is determined based on at least one of: the ID of the at least one second node; and the type of the at least one second node.

In an embodiment, the method further comprises receiving by the at least one first node capability of the at least one second node.

In an embodiment, the at least one second message comprises capability of the at least one second node.

In an embodiment, the capability comprises at least one of: at least one frequency supported; at least one bandwidth supported; a multiplexing capability; a type of the at least one second node; a backscattering capability; a transmission capability; an amplification capability; an energy harvesting capability; an information about charging/discharging cycle; a minimum time duration between consecutive transmission; a minimum time duration between consecutive reception; a minimum time duration between consecutive transmission and reception; and a minimum time duration between consecutive reception and transmission.

In an embodiment, the response message further comprises at least one of: an indication of completion of identification process; ID of the at least one second node; the at least one identifier; an information for generating the at least one identity of the at least one second node; TA corresponding to the at least one second node; a scheduling information for at least one fourth message; and an information about content of the at least one fourth message.

In an embodiment, the information about content comprises: an indication to include at least one of identity of the at least one second node, sensor output, location information and measured value as content, and a granularity of the content.

In an embodiment, the scheduling information for the fourth signal comprises at least one of: a start time of the fourth signal; a duration of the fourth signal; a periodicity of the fourth signal; a frequency of the fourth signal; and a frequency shift in the fourth signal.

In an embodiment, the identity of the at least one second node comprises at least one of: an identity of the device type; an identity of location of the device; an identity of the service request; an identity of the at least one first node; and an identity specific to the device.

In an embodiment, the method further comprises receiving, by the at least one first node, at least one third signal, wherein the at least one third signal comprises at least one of identity of the at least one second node, sensor output, location information and measured value.

In an embodiment, the first message further comprises a re-access flag.

In an embodiment, the re-access flag is used to indicate the at least one second node to perform a re-transmission of the second message.

In an embodiment, the re-access flag is used to indicate the at least one second node to perform re-transmission using one of: the at least one resource in the first message without re-access flag; and at least one resource in the first message with re-access flag.

In an embodiment, the field for the at least one resource for transmission of the second message is muted in the first message with re-access flag.

In an embodiment, the method further comprises, transmitting, by the at least one first node, the first message further comprises transmitting an activation signal to activate content of the first message.

In an embodiment, the activation signal further comprises a re-access flag.

In an embodiment, the method further comprises at least one of: adding, by the at least one first node, the at least one identity of the at least one second node to a list; and removing, by the at least one first node, the at least one identity of the at least one second node from the list.

In an embodiment, the list comprises a list of identified second nodes.

In an embodiment, wherein removing is based on at least one of: one or more identifying attempts; an energy status of the at least one second device; and an information from at least one node.

In an embodiment, wherein in the at least one node is at least one of: at least one first node; an identified second node; and in proximity of the at least one second node.

In an embodiment, the at least one first node is any one of a handheld device, a base station, a use equipment (UE), Network-Controlled Repeater (NCR), Integrated Access and Backhaul (IAB), repeater, or any combination thereof.

In an embodiment, the at least one second node is one of BS, UE, Ambient IoT device, NCR, IAB, carrier wave node, non-RF device or active RF device.

In an embodiment, the Ambient IoT device is a tag, which is attached to any one of a passive device, an active device and a sensor.

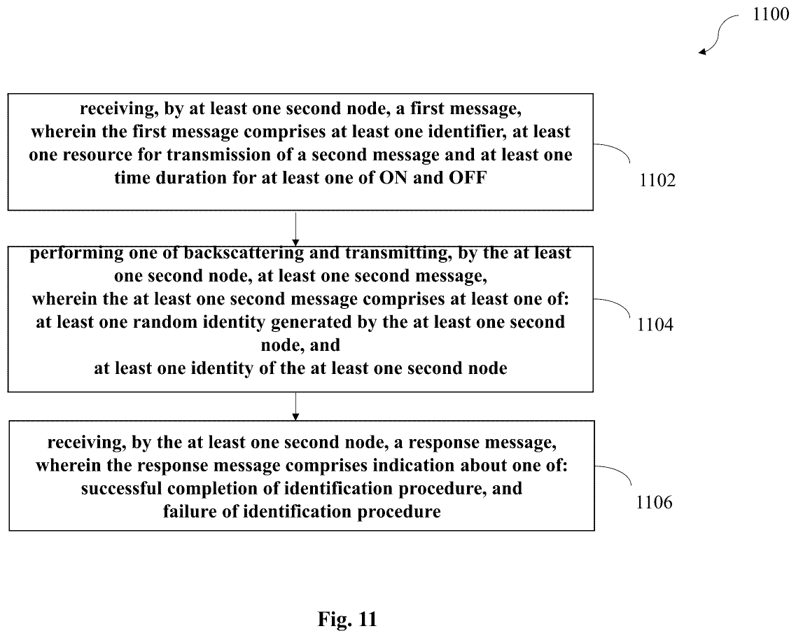

FIG. 11 illustrates a method of identifying nodes in a wireless communication system in accordance with an embodiment of the present disclosure. The operations of method 1100 presented below are intended to be illustrative. In some implementations, method 1100 may be accomplished with one or more additional operations not described, and/or without one or more of the operations discussed. Additionally, the order in which the operations of method 1100 are illustrated in FIG. 11 and described below is not intended to be limiting.

According to an embodiment, the method 1100 may be implemented by one or more processors or modules illustrated and explained through FIGS. 1-5, therefore detailed explanation of the same is omitted here for the sake of brevity.

Step 1102 may include receiving, by at least one second node, a first message, wherein the first message comprises at least one identifier, at least one resource for transmission of a second message and at least one time duration for at least one of ON and OFF.

Step 1104 may include performing one of backscattering and transmitting, by the at least one second node, at least one second message, wherein the at least one second message comprises at least one of: at least one random identity generated by the at least one second node, and at least one identity of the at least one second node.

Step 1106 may include receiving, by the at least one second node, a response message, wherein the response message comprises indication about one of: successful completion of identification procedure, and failure of identification procedure.

In an embodiment, the at least one identifier comprises at least one of: an identity of a service request; an identity of at least one first node; and at least one identity of the at least one second node.

In an embodiment, the at least one resource for the second message comprises at least one of: at least one time resource; at least one time offset; at least one periodicity; at least one frequency resource; at least one frequency shift; a carrier frequency; at least one spatial resource; and at least one power control information.

In an embodiment, the at least one spatial resource comprises at least one identity of one of a beam and a precoder.

In an embodiment, the time is represented using at least one of a slot index, a number of slots, a symbol index and a number of symbols.

In an embodiment, the frequency resource is represented using at least one of a resource block index, a sub carrier spacing, a number of resources blocks, a subcarrier index, identity of at least one bandwidth part and a number of subcarriers.

In an embodiment, the first message further comprises at least one of: an indication for the at least one second node to start receiving; an information about the clock; at least one information to generate at least one of: the at least one random identity, and the at least one identity of the at least one second node; an indication for one of transmit and backscatter the second message; an information about content of the second message; an indication for one of perform modulation and skip modulation on the second message; at least one orthogonal sequence; at least one preamble ID; at least one root sequence; and at least one shifting factor.

In an embodiment, receiving the first message further comprises generating at least one of: the at least one random identity; and the at least one identity of the at least one second node.

In an embodiment, generating is based on at least one of: at least one information indicated in the first message; a type of the at least one second node; a capability of the at least one second node; and a location of the at least one second node.

In an embodiment, the method further comprises: transmitting, by the at least one second node, capability of the at least one second node.

In an embodiment, performing one of backscattering and transmitting the at least one second message comprises modulating the carrier wave using at least one of: the at least one random identity; the at least one identity of the at least one second node; an information stored in the at least one second node; at least one value measured by the at least one second node; capability of the at least one second node; a preamble; a reference signal; and a sequence.

In an embodiment, the at least one of the at least one identity, the preamble, the reference signal, and the sequence is one of a predefined and indicated in the first message.

In an embodiment, the capability of the at least one second node comprises at least one of: at least one frequency supported; at least one bandwidth supported; a multiplexing capability; a type of the device; a backscattering capability; a transmission capability; an amplification capability; an energy harvesting capability; supported use cases; an information about charging/discharging cycle; a minimum time duration between consecutive transmission; a minimum time duration between consecutive reception; a minimum time duration between consecutive transmission and reception; and a minimum time duration between consecutive reception and transmission.

In an embodiment, the response message further comprises at least one of: the at least one identifier; information for generating the at least one identity of the at least one second node; TA corresponding to the at least one second node; a scheduling information for at least one fourth message; and an information about content of the at least one fourth message.

In an embodiment, the information about content comprises: an indication to include at least one of identity of the at least one second node, sensor output, location information and measured value as content; and a granularity of the content.

In an embodiment, the scheduling information for the fourth signal comprises at least one of: TA corresponding to the fourth signal; a start time of the fourth signal; a duration of the fourth signal; a periodicity of the fourth signal; a frequency of the fourth signal; and a frequency shift in the fourth signal.

In an embodiment, the method further comprises performing one of backscattering and transmitting, by the at least one second node, at least one third signal, wherein the at least one third signal comprises at least one of identity of the at least one second node, sensor output, location information and measured value.

In an embodiment, the indication about successful completion of identification procedure comprises at least one of: at least one random identity; and at least one identity of the at least one second node.

In an embodiment, the indication about successful completion of identification procedure is one of the same and a subset of the at least one second message.

In an embodiment, receiving the indication about successful completion of identification procedure in the response message further comprises ignoring the first message with re-access flag.

In an embodiment, receiving the indication about failure of identification procedure in the response message further comprises at least one of: monitoring for a first message with re-access flag; receiving the first message with re-access flag; and performing one of backscattering and transmitting the second message.

In an embodiment, the first message with re-access flag comprises the at least one identifier.

In an embodiment, the field for at least one resource for transmission of a second message is muted in the first message with re-access flag.

In an embodiment, performing one of backscattering and transmitting the second message is in one of: at least one resource indicated in the first message with re-access flag; and the at least one resource for transmission of a second message.

In an embodiment, performing one of backscattering and transmitting the second message comprises: ignoring further reception of the first message.

In an embodiment, receiving the first message further comprises receiving an activation signal to activate content of the first message.

In an embodiment, the activation signal comprises a re-access flag.

In an embodiment, receiving the response message further comprises: receiving at least one identity.

In an embodiment, the method further comprises: comparing the at least one identity with at least one of the at least one random identity and the at least one identity of the at least one second node included in the second message; and declare passed if a match is found or retry later if no match is found.

In an embodiment, the at least one first node is any one of a handheld device, a base station, a use equipment (UE), Network-Controlled Repeater (NCR), Integrated Access and Backhaul (IAB), repeater, or any combination thereof.

In an embodiment, the at least one second node is one of BS, UE, Ambient IoT device, NCR, IAB, carrier wave node, non-RF device or active RF device.

In an embodiment, the Ambient IoT device is a tag, which is attached to any one of a passive device, an active device and a sensor.

In an embodiment, performing one of backscattering and transmitting the at least one third signal is based on at least one of timing advance and scheduling information indicated in the second message.

The figures of the disclosure are provided to illustrate some examples of the invention described. The figures are not to limit the scope of the depicted embodiments of the appended claims. Aspects of the disclosure are described herein with reference to the invention to example embodiments for illustration. It should be understood that specific details, relationships, and method are set forth to provide a full understanding of the example embodiments. One of ordinary skill in the art recognize the example embodiments can be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

It is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

We claim:

1. A method of identifying nodes in a wireless communication system, the method comprising:
transmitting, by at least one first node, a first message,
wherein the first message comprises at least one identifier, at least one resource for transmission of a second message by at least one second node and at least one time duration for at least one of ON and OFF;
receiving, by the at least one first node, at least one second message,
wherein the at least one second message comprises at least one of:
at least one random identity generated by the at least one second node, and
at least one identity of the at least one second node; and
transmitting, by the at least one first node, a response message,
wherein the response message comprises at least one of:
at least one random identity, and
at least one identity of the at least one second node.

2. The method as claimed in claim 1, wherein the response message is one of the same and a subset of the at least one second message.

3. The method as claimed in claim 1, wherein the at least one identifier comprises at least one of:
an identity of a service request;
an identity of the at least one first node; and
at least one identity of the at least one second node.

4. The method as claimed in claim 1, wherein the at least one resource for the second message comprises at least one of:
at least one time resource;
at least one time offset;
at least one periodicity;
at least one frequency resource;
at least one frequency shift;
a carrier frequency;
at least one spatial resource; and
at least one power control information.

5. The method as claimed in claim 4, wherein the at least one spatial resource comprises at least one identity of one of a beam and a precoder.

6. The method as claimed in claim 4, wherein the time is represented using at least one of a slot index, a number of slots, a symbol index and a number of symbols.

7. The method as claimed in claim 4, wherein the frequency resource is represented using at least one of a resource block index, a sub carrier spacing, a number of resources blocks, a subcarrier index, identity of at least one bandwidth part and a number of subcarriers.

8. The method as claimed in claim 1, wherein the at least one second message comprises at least one of a preamble, a reference signal, a sequence and a carrier wave.

9. The method as claimed in claim 8, wherein the at least one of the preamble, the reference signal, and the sequence is one of a predefined and indicated in the first message.

10. The method as claimed in claim 1, wherein the first message further comprises at least one of:
an indication for the at least one second node to start receiving, an information about the clock,
at least one information to generate at least one of:
the at least one random identity, and
the at least one identity of the at least one second node;
an indication for one of transmit and backscatter the second message;
an information about content of the second message;
an indication for one of perform modulation and skip modulation on the second message;
at least one orthogonal sequence;
at least one preamble ID;
at least one root sequence; and
at least one shifting factor.

11. The method as claimed in claim 1, wherein receiving the at least one second message further comprises at least one of:
identifying the at least one second node from where the at least one second message is received; and
determining at least one parameter corresponding to the at least one second node identified.

12. The method as claimed in claim 11, wherein the at least one parameter is determined using at least one of:
at least one of a preamble, a reference signal, a sequence and an information modulated in the at least one second message; and
a received power of the at least one second message.

13. The method as claimed in claim 11, wherein the at least one parameter comprises at least one of:
an identity (ID) of the at least one second node;
a type of the at least one second node;
a capability of the at least one second node;
a channel of the at least one second node;
a timing advance (TA) corresponding to the at least one second node;
a propagation delay corresponding to the at least one second node;
a proximity of the at least one second node;
a position of the at least one second node;
a processing time at the at least one second node;
an energy status of the at least one second node; and
an information about energy harvesting at the at least one second node.

14. The method as claimed in claim 11, wherein the at least one parameter is determined for one of:
a link between the at least one first node and a third node through the at least one second node; and
a link between the at least one first node and the at least one second node.

15. The method as claimed in claim 13, wherein the type of the at least one second node is determined based on the ID of the at least one second node.

16. The method as claimed in claim 13, wherein the capability of the at least one second node is determined based on at least one of:
the ID of the at least one second node; and
the type of the at least one second node.

17. The method as claimed in claim 1, further comprises receiving by the at least one first node capability of the at least one second node.

18. The method as claimed in claim 1, wherein the at least one second message comprises capability of the at least one second node.

19. The method as claimed in at least one of claim 13, claim 17 and claim 18, wherein the capability comprises at least one of:
at least one frequency supported;
at least one bandwidth supported;
a multiplexing capability;
a type of the at least one second node;
a backscattering capability;
a transmission capability;
an amplification capability;
an energy harvesting capability;
an information about charging/discharging cycle;
a minimum time duration between consecutive transmission;
a minimum time duration between consecutive reception;
a minimum time duration between consecutive transmission and reception; and
a minimum time duration between consecutive reception and transmission.

20. The method as claimed in claim 1, wherein the response message further comprises at least one of:
an indication of completion of identification process;
ID of the at least one second node;
the at least one identifier;
an information for generating the at least one identity of the at least one second node;
TA corresponding to the at least one second node;
a scheduling information for at least one fourth message; and
an information about content of the at least one fourth message.

21. The method as claimed in at least one of claim 10 and claim 20, wherein the information about content comprises:
an indication to include at least one of identity of the at least one second node, sensor output, location information and measured value as content, and a granularity of the content.

22. The method as claimed in claim 20, wherein the scheduling information for the fourth signal comprises at least one of:
a start time of the fourth signal;
a duration of the fourth signal;
a periodicity of the fourth signal;
a frequency of the fourth signal; and
a frequency shift in the fourth signal.

23. The method as claimed in claim 1, wherein the identity of the at least one second node comprises at least one of:
an identity of the device type;
an identity of location of the device;
an identity of the service request;
an identity of the at least one first node; and
an identity specific to the device.

24. The method as claimed in claim 1, further comprises receiving, by the at least one first node, at least one third signal,
wherein the at least one third signal comprises at least one of identity of the at least one second node, sensor output, location information and measured value.

25. The method as claimed in claim 1, wherein the first message further comprises a re-access flag.

26. The method as claimed in claim 25, wherein the re-access flag is used to indicate the at least one second node to perform a re-transmission of the second message.

27. The method as claimed in 26, wherein the re-access flag is used to indicate the at least one second node to perform re-transmission using one of:
the at least one resource in the first message without re-access flag; and
at least one resource in the first message with re-access flag.

28. The method as claimed in claim 25, wherein the field for the at least one resource for transmission of the second message is muted in the first message with re-access flag.

29. The method as claimed in claim 1, transmitting, by the at least one first node, the first message further comprises transmitting an activation signal to activate content of the first message.

30. The method as claimed in claim 29, wherein the activation signal further comprises a re-access flag.

31. The method as claimed in claim 1, further comprises at least one of:
adding, by the at least one first node, the at least one identity of the at least one second node to a list; and
removing, by the at least one first node, the at least one identity of the at least one second node from the list.

32. The method as claimed in claim 31, wherein the list comprises a list of identified second nodes.

33. The method as claimed in claim 31, wherein removing is based on at least one of:
one or more identifying attempts;
an energy status of the at least one second device; and
an information from at least one node.

34. The method as claimed in claim 22, wherein in the at least one node is at least one of:
at least one first node;
an identified second node; and
in proximity of the at least one second node.

35. The method as claimed in claim 1, wherein the at least one first node is any one of a handheld device, a base station, a reader, A-IoT reader, a use equipment (UE), Network-Controlled Repeater (NCR), Integrated Access and Backhaul (IAB), repeater, or any combination thereof.

36. The method as claimed in claim 1, wherein the at least one second node is one of BS, UE, Ambient IoT device, NCR, IAB, carrier wave node, non-RF device or active RF device.

37. The method as claimed in claim 35, wherein the Ambient IoT device is a tag, which is attached to any one of a passive device, an active device and a sensor.

38. A method of identifying nodes in a wireless communication system, the method comprising:
receiving, by at least one second node, a first message,
wherein the first message comprises at least one identifier, at least one resource for transmission of a second message and at least one time duration for at least one of ON and OFF;
performing one of backscattering and transmitting, by the at least one second node, at least one second message,
wherein the at least one second message comprises at least one of:
at least one random identity generated by the at least one second node, and
at least one identity of the at least one second node; and
receiving, by the at least one second node, a response message,
wherein the response message comprises indication about one of:
successful completion of identification procedure, and
failure of identification procedure.

39. The method as claimed in claim 38, wherein the at least one identifier comprises at least one of:
an identity of a service request;
an identity of at least one first node; and
at least one identity of the at least one second node.

40. The method as claimed in claim 38, wherein the at least one resource for the second message comprises at least one of:
at least one time resource;
at least one time offset;
at least one periodicity;
at least one frequency resource;
at least one frequency shift;
a carrier frequency;
at least one spatial resource; and
at least one power control information.

41. The method as claimed in claim 40, wherein the at least one spatial resource comprises at least one identity of one of a beam and a precoder.

42. The method as claimed in claim 40, wherein the time is represented using at least one of a slot index, a number of slots, a symbol index and a number of symbols.

43. The method as claimed in claim 40, wherein the frequency resource is represented using at least one of a resource block index, a sub carrier spacing, a number of resources blocks, a subcarrier index, identity of at least one bandwidth part and a number of subcarriers.

44. The method as claimed in claim 38, wherein the first message further comprises at least one of:
an indication for the at least one second node to start receiving;
an information about the clock;
at least one information to generate at least one of:
the at least one random identity, and
the at least one identity of the at least one second node;
an indication for one of transmit and backscatter the second message;
an information about content of the second message;
an indication for one of perform modulation and skip modulation on the second message;
at least one orthogonal sequence;
at least one preamble ID;
at least one root sequence; and
at least one shifting factor.

45. The method as claimed in claim 38, wherein receiving the first message further comprises generating at least one of:
the at least one random identity; and
the at least one identity of the at least one second node.

46. The method as claimed in claim 45, wherein generating is based on at least one of:
at least one information indicated in the first message;
a type of the at least one second node;
a capability of the at least one second node; and
a location of the at least one second node.

47. The method as claimed in claim 38, further comprises:
transmitting, by the at least one second node, capability of the at least one second node.

48. The method as claimed in claim 38, wherein performing one of backscattering and transmitting the at least one second message comprises modulating the carrier wave using at least one of:
the at least one random identity;
the at least one identity of the at least one second node;
an information stored in the at least one second node;
at least one value measured by the at least one second node;
capability of the at least one second node;
a preamble;
a reference signal; and
a sequence.

49. The method as claimed in claim 48, wherein the at least one of the at least one identity, the preamble, the reference signal, and the sequence is one of a predefined and indicated in the first message.

50. The method as claimed in claim 46, wherein the capability of the at least one second node comprises at least one of:
at least one frequency supported;
at least one bandwidth supported;
a multiplexing capability;
a type of the device;
a backscattering capability;
a transmission capability;
an amplification capability;
an energy harvesting capability;
supported use cases;
an information about charging/discharging cycle;
a minimum time duration between consecutive transmission;
a minimum time duration between consecutive reception;
a minimum time duration between consecutive transmission and reception; and
a minimum time duration between consecutive reception and transmission.

51. The method as claimed in claim 38, wherein the response message further comprises at least one of:
the at least one identifier;
information for generating the at least one identity of the at least one second node;
TA corresponding to the at least one second node;
a scheduling information for at least one fourth message; and
an information about content of the at least one fourth message.

52. The method as claimed in at least one of claim 44 and claim 51, wherein the information about content comprises:
an indication to include at least one of identity of the at least one second node, sensor output, location information and measured value as content; and
a granularity of the content.

53. The method as claimed in claim 51, wherein the scheduling information for the fourth signal comprises at least one of:
TA corresponding to the fourth signal;
a start time of the fourth signal;
a duration of the fourth signal;
a periodicity of the fourth signal;
a frequency of the fourth signal; and
a frequency shift in the fourth signal.

54. The method as claimed in claim 38, further comprises performing one of backscattering and transmitting, by the at least one second node, at least one third signal,
wherein the at least one third signal comprises at least one of identity of the at least one second node, sensor output, location information and measured value.

55. The method as claimed in claim 38, wherein the indication about successful completion of identification procedure comprises at least one of:
at least one random identity; and
at least one identity of the at least one second node.

56. The method as claimed in claim 38, wherein the indication about successful completion of identification procedure is one of the same and a subset of the at least one second message.

57. The method as claimed in claim 38, wherein receiving the indication about successful completion of identification procedure in the response message further comprises ignoring the first message with re-access flag.

58. The method as claimed in claim 38, wherein receiving the indication about failure of identification procedure in the response message further comprises at least one of:
monitoring for a first message with re-access flag;
receiving the first message with re-access flag; and
performing one of backscattering and transmitting the second message.

59. The method as claimed in claim 58, wherein the first message with re-access flag comprises the at least one identifier.

60. The method as claimed in claim 58, wherein the field for at least one resource for transmission of a second message is muted in the first message with re-access flag.

61. The method as claimed in claim 58, wherein performing one of backscattering and transmitting the second message is in one of:
at least one resource indicated in the first message with re-access flag; and
the at least one resource for transmission of a second message.

62. The method as claimed in claim 38, wherein performing one of backscattering and transmitting the second message comprises:
ignoring further reception of the first message.

63. The method as claimed in claim 38, wherein receiving the first message further comprises receiving an activation signal to activate content of the first message.

64. The method as claimed in claim 63, wherein the activation signal comprises a re-access flag.

65. The method as claimed in claim 38, wherein receiving the response message further comprises:
receiving at least one identity.

66. The method as claimed in claim 65, further comprises:
comparing the at least one identity with at least one of the at least one random identity and the at least one identity of the at least one second node included in the second message; and
declare passed if a match is found or retry later if no match is found.

67. The method as claimed in claim 38, wherein the at least one first node is any one of a handheld device, a base station, a reader, A-IoT reader, a use equipment (UE), Network-Controlled Repeater (NCR), Integrated Access and Backhaul (IAB), repeater, or any combination thereof.

68. The method as claimed in claim 38, wherein the at least one second node is one of BS, UE, Ambient IoT device, NCR, IAB, carrier wave node, non-RF device or active RF device.

69. The method as claimed in claim 68, wherein the Ambient IoT device is a tag, which is attached to any one of a passive device, an active device and a sensor.

70. The method as claimed in claim 54, wherein performing one of backscattering and transmitting the at least one third signal is based on at least one of timing advance and scheduling information indicated in the second message.
